(19) United States
(12) Patent Application Publication
(10) Pub. No.: US 2017/0082469 A1
(43) Pub. Date: Mar. 23, 2017

(54) INLINE ULTRASONIC METER (USM) CONDITION BASED MONITORING (CBM)-BASED ADAPTATION TO MAINTAIN HIGH ACCURACY UNDER VARIOUS FLOW CONDITIONS

(71) Applicant: Honeywell International Inc., Morristown, NJ (US)

(72) Inventors: Bin Sai, Den Haag (NL); Michael Teufel, Kraichtal (DE); Andreas Weber, Huettenberg (DE); David Bachmann, Ludwigshafen (DE)

(21) Appl. No.: 14/860,512

(22) Filed: Sep. 21, 2015

(51) Int. Cl. G01F 1/66

(52) U.S. Cl. CPC G01F 1/66

(57) ABSTRACT

A system includes a control system and a field device. The control system is configured to communicate data with the field device. The field device determines whether a deviation in a measurement accuracy of a first characteristic curve for a flow profile of a process fluid is detected while monitoring an inline condition of the process fluid. The field device determines whether the deviation is greater than an application tolerance. The field device also performs an inline recalculation for a new characteristic curve according to present flow condition detected in measurements of the flow profile when the deviation is greater than the application tolerance. The field device calculates a flow rate of the process fluid using the new characteristic curve.

### CROSS-REFERENCE TO OTHER APPLICATION

This application shares some subject matter with commonly-assigned, concurrently filed U.S. patent application Ser. No. ______ (docket number: H0050162-0112) for “Real-Time Condition Based Monitoring (CBM) Based Ultrasonic Meter (USM) Accuracy Performance Detection and Notification,” which is hereby incorporated by reference.

### TECHNICAL FIELD

This disclosure is generally directed to condition based monitoring. More specifically, this disclosure is directed to inline USM CBM-based adaptation to maintain high accuracy under various flow conditions.

### BACKGROUND

The speed of sound in natural gas is typically between 300 m/s and 450 m/s, while the maximum gas velocity is about 40 m/s in a pipe. For the International Organization of Legal Metrology (OIML) class 0.5, the maximum acceptable error is 0.07 m/s with an averaging time of approximately 20 minutes, provided that the inner diameter of the spool is unchanged.

### SUMMARY

This disclosure provides an apparatus and method for inline USM CBM-based adaptation to maintain high accuracy under various flow conditions.

In a first embodiment, a system is provided. The system includes a control system and a field device. The control system is configured to communicate data with one or more field devices. The field device determines whether a deviation in a measurement accuracy of a first characteristic curve for a flow profile of a process fluid is detected while monitoring an inline condition of the process fluid. The field device determines whether the deviation is greater than an application tolerance. The field device also performs an inline recalculation for a new characteristic curve according to present flow condition detected in measurements of the flow profile when the deviation is greater than the application tolerance. The field device calculates a flow rate of the process fluid using the new characteristic curve.

In a second embodiment, a field device is provided. The field device determines whether a deviation in a measurement accuracy of a first characteristic curve for a flow profile of a process fluid is detected while monitoring an inline condition of the process fluid. The field device determines whether the deviation is greater than an application tolerance. The field device also performs an inline recalculation for a new characteristic curve according to present flow condition detected in measurements of the flow profile when the deviation is greater than the application tolerance. The field device calculates a flow rate of the process fluid using the new characteristic curve.

In a third embodiment, a method is provided. The method includes determining whether a deviation in a measurement accuracy of a first characteristic curve for a flow profile of a process fluid is detected while monitoring an inline condition of the process fluid. The method also includes determining whether the deviation is greater than an application tolerance. The method further includes performing an inline recalculation for a new characteristic curve according to present flow condition detected in measurements of the flow profile when the deviation is greater than the application tolerance. The method also includes calculating a flow rate of the process fluid using the new characteristic curve.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example industrial control and automation system having a field device according to this disclosure;

FIG. 2 illustrates different notifications of accuracy performance detection from a field device according to this disclosure;

FIG. 3 illustrates different examples of pipes with bends that affect the flow profile of the fluid according to this disclosure;

FIGS. 4A and 4B illustrate examples of potential disturbed profiles according to this disclosure;

FIG. 5 illustrates a method for CBM-based accuracy performance detection according to this disclosure; and

FIG. 6 illustrates an example CBM display for a field device according to this disclosure.

### DETAILED DESCRIPTION

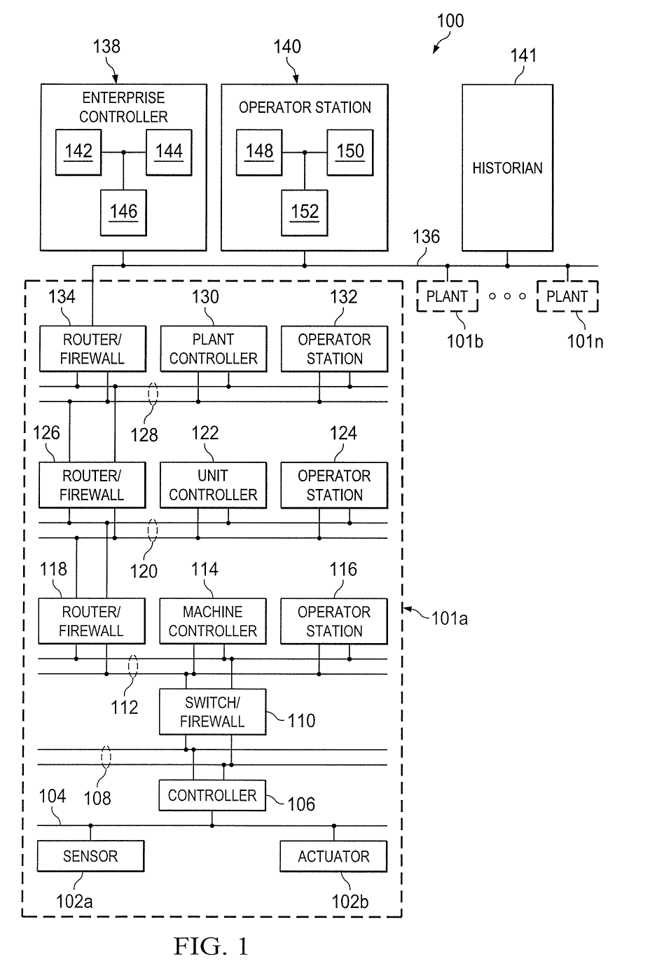

FIGS. 1 through 6, discussed below, and the various examples used to describe the principles of the present invention in this patent document are by way of illustration only and should not be construed in any way to limit the scope of the invention. Those skilled in the art will understand that the principles of the present invention may be implemented in any suitable manner and in any type of suitably arranged device or system.

Condition-based monitoring (CBM) is often used in ultrasonic flow meters. Currently, CBM is used for equipment and process condition monitoring to provide diagnostic information and data for offline analysis and necessary maintenance planning. The inline adaptability of the metering equipment to real-time in-situ conditions is required to be maintenance “free” or have longer periods of maintenance cycles.

With newly proposed ultrasonic meter (USM) CBM methodology, the items for monitoring and diagnostics include hardware related aspects such as component aging or wear-out, contamination, etc. Other items for monitoring and diagnostics for the newly proposed USM CBM methodology include software related improvement/tuning/optimization associated with changes of flow measurement conditions like temperature, pressure, fluid composition, flow velocity profile, and so on. The impact of variations of these conditions is eventually imposed on the volumetric flow rate across the designated measuring cross-section.

In some current calculation schemes for flow rate calculation, once the characteristic correction curve is calculated during calibration, it remains in use in the field until the next USM offline maintenance or calibration takes place. The characteristic curve's dependence on the meter data measured during calibrations makes it prone to erroneous discrepancy when the practical measurement conditions such as flow profile are deviated from what is obtained from the offline calibration. As a consequence, the curve correction could lead to a shift or larger deviation of accuracy exceeding the upper or lower limit boundary, leading to difficulty for complying with various practical flow conditions. For example, under disturbance conditions (e.g., with double bends out of plane (DBOP)) the flow profile can be deviated with different upstream pipe length, whereby the USM measurement accuracy can be changed accordingly from insertion of spool length, such as 5 D, 10 D, 20 D. In practice, although status indication of diagnostic parameters might be provided, the real-time accuracy performance of the USM is not always clear. This disclosure addresses maintaining the accuracy within the tolerance range without offline calibration when the “out of boundary” is detected.

In order to deal with the issues noted above related to accuracy performance due to flow condition change, besides inline detection, embodiments of this disclosure provide a method of real-time adaptation and optimization. The method is composed of the adaptive algorithm scheme to tune the USM calculation model in a way that the equipment measurement accuracy is maintained optimally within the limit over a long period of time and under various practical conditions. The disclosed embodiments use the CBM information as an input to perform real-time recalculation of a nonlinear error correction curve such as polynomial coefficients, so every measurement profile will have its own optimal error correction that can truly reflect the real-time flow condition profile sensed by the USM.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an ultrasonic pulse network (such as a HART, FOUNDATION FIELDBUS, MODBUS, etc.), a pneumatic control signal network, a wireless network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Multiple controllers 106 could also operate in redundant configurations, such as when one controller 106 operates as a primary controller while another controller 106 operates as a backup controller (which synchronizes with the primary controller and can take over for the primary controller in the event of a fault with the primary controller). Each controller 106 includes any suitable structure for interacting with one or more sensors 102a and controlling one or more actuators 102b. Each controller 106 could, for example, represent a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers could include one or more processing devices 142 and one or more memories 144 for storing instructions and data used, generated, or collected by the processing device(s) 142. Each of the controllers could also include at least one network interface 146, such as one or more Ethernet interfaces or wireless transceivers. Also, each of the operator stations could include one or more processing devices 148 and one or more memories 150 for storing instructions and data used, generated, or collected by the processing device(s) 148. Each of the operator stations could also include at least one network interface 152, such as one or more Ethernet interfaces or wireless transceivers.

Although FIG. 1 illustrates one example of an industrial process control and automation system 100, various changes may be made to FIG. 1. For example, a control system could include any number of sensors, actuators, controllers, servers, operator stations, and networks. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, process control systems are highly configurable and can be configured in any suitable manner according to particular needs.

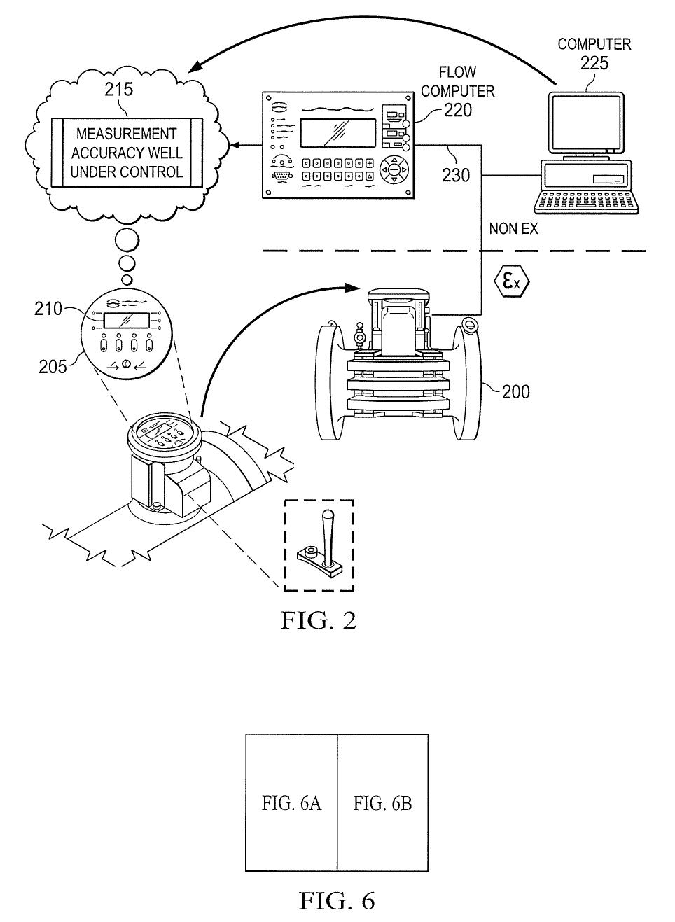

FIG. 2 illustrates different notifications of accuracy performance detection as well as notification of change of the characteristic curve from a field device 200 according to this disclosure. For ease of explanation, the field device 200 is described as being used in the system 100 of FIG. 1. For example, the field device 200 may represent (or be represented by) a sensor 102a, an actuator 102b, a controller 106, another component, or a combination of components described in FIG. 1. However, the field device 200 could be used in any other suitable system.

The field device 200 represents a device or system that is installed in a pipeline for measuring the fluid flow through the pipeline. Relative directions and locations within the field device 200 are described with respect to the direction of the fluid flow, where “upstream” indicates where the fluid flow enters the field device 200 and “downstream” indicates where the fluid flow exits the field device 200. While the illustrated embodiments illustrate fluid flow in a single direction, the field device 200 can measure fluid flow in both directions. The field device 200 includes a control interface 205 with a display 210. The field device 200 is connected to a flow computer 220 or a computer 225 both with displays 210. The flow computer 220 and computer 225 can be connected to the field device 200 or to each other through a wired (e.g., MODBUS) or wireless connection 230.

The control interface 205 includes one or more controls to change the display 210 to display different functions or processes monitored by the field device 200. The display 210 can include a message 215 that informs a user of the level of accuracy measurement of the field device 200.

In certain embodiments, the message 215 states, for example, “measurement accuracy well under control” for accurate measurement conditions of the field device 200, “measurement accuracy might be affected or altered” for inaccurate measurement conditions, or “the characteristic curve is changed.” The second message suggests action of further investigation and verification, implying that the accuracy could be reduced significantly either within acceptable tolerances for less accurate measurement conditions close to the limit of an acceptable range or outside an acceptable range. The later will result in recalculation of the characteristic curve to correct the influence on the measurement accuracy. The display 210 can also indicate the accuracy level of the measurement conditions using different colors, for example, green for excellent accuracy conditions, yellow for acceptable accuracy conditions, red for unacceptable accuracy conditions, and blue for a change of the characteristic curve. The display 210 can also use flashing states to indicate the accuracy conditions, for example, no flashing for excellent accuracy conditions, slow flashing for acceptable accuracy conditions, quick flashing for unacceptable accuracy conditions, and twice quick flashing for the change of characteristic curve.

In certain embodiments, the field device 200 can incorporate a direct path or reflective path transit time between transmitting and receiving (Tx/Rx) pairs as the measuring principle for the CBM based accuracy monitoring. The field device 200 can use a number of USM transducers to calculate different velocities across a flow profile. In certain embodiments, the field device 200 determines the velocity across a number of paths, such as four, five, six, or eight paths, in order to determine the flow rate. The measuring accuracy for such devices can be less than a percentage of error, such as 0.5%, for dry calibration with nitrogen accuracy or less than a percentage of error, such as 0.1%, for HP-flow calibration across the full measuring range of Q₁ to Qₘₐₓ. The field device 200 includes a maximum measuring range, such as 0.25-40 m/s, for a maximum velocity depend on the meter size of the field device 200, such as six inches.

The field device 200 is capable of performing different diagnosis operations including path gain data (PGD), transducer path performance level (TPPL), waveform, flow pass velocity (FPV), flow velocity profile factor (FVPF), path speed of sound (PSoS), sound velocity profile factor (SVPF), signal to noise ratio (SNR), cross-flow, swirl angle, etc. The field device 200 also monitors different continuous diagnostics parameters such as asymmetry, turbulence, average gas velocity, average measure speed of sound, flow rate history, calculated speed of sound, an angle of flow, etc. Parameters or properties associated with the field device 200 can include a USM voltage, metrology configuration checksum, hardware identification (HW ID), firmware/software identification (FW/SW ID), and user configuration checksum on a startup monitor.

The field device 200 can incorporate predictive alerts such as detection of deviation of a number of diagnostic parameters from a baseline. The field device 200 can also incorporate actionable alerts such as an abnormal profile alert, a liquid detection alert, and a speed of sound deviation alert. The field device 200 can include alarms such as a display of new latched alarms, severity alarm display, and an indication of possible cause of alarm.

The field device 200 can include custody transfer (CT) application coverage. The field device 200 can include a low susceptibility to noise and contamination, and can conform to various standards including, but not limited to, American Gas Association (AGA) 9, ISO 17089, Oganisation Internationale Metrologie Legale (OIML) 137-2012, AGA 10, pattern approval measuring instruments directive (MID), Physikalisch-Technische Bundesanstalt (PTB), and Measurement Canada. The field device 200 also includes real-time validation capability, inline diagnostics, prediction on maintenance and schedule, output of diagnostic data in feedback loop compensation to extend a maintenance period by self-correction and minimizing uncertainties.

Although FIG. 2 illustrates details of an example field device 200, various changes may be made to FIG. 2. For example, the number(s) and type(s) of components shown in FIG. 2 are for illustration only. Also, the functional divisions of the field device 200 shown in FIG. 2 are for illustration only. Various components in FIG. 2 could be omitted, combined, or further subdivided and additional components could be added according to particular needs.

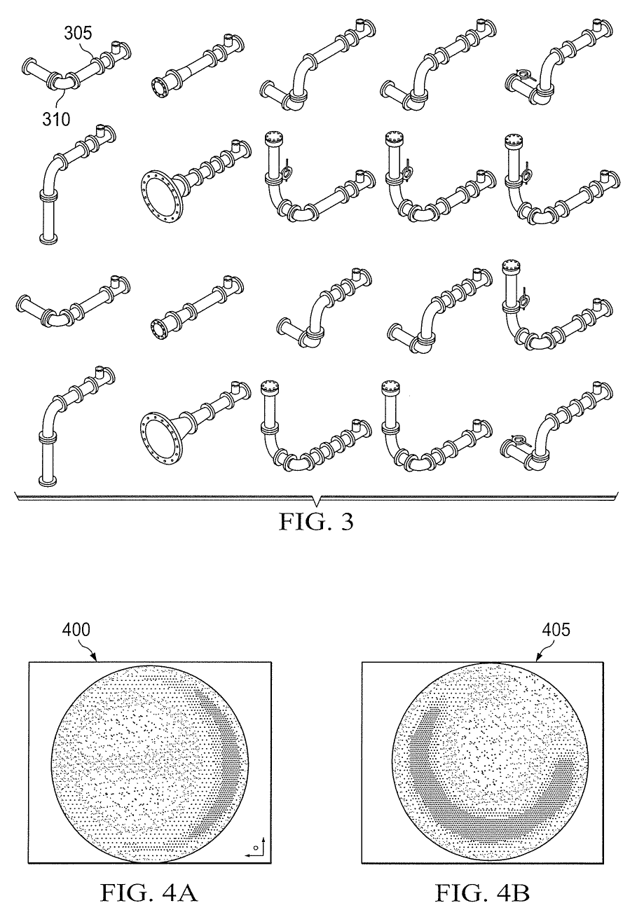

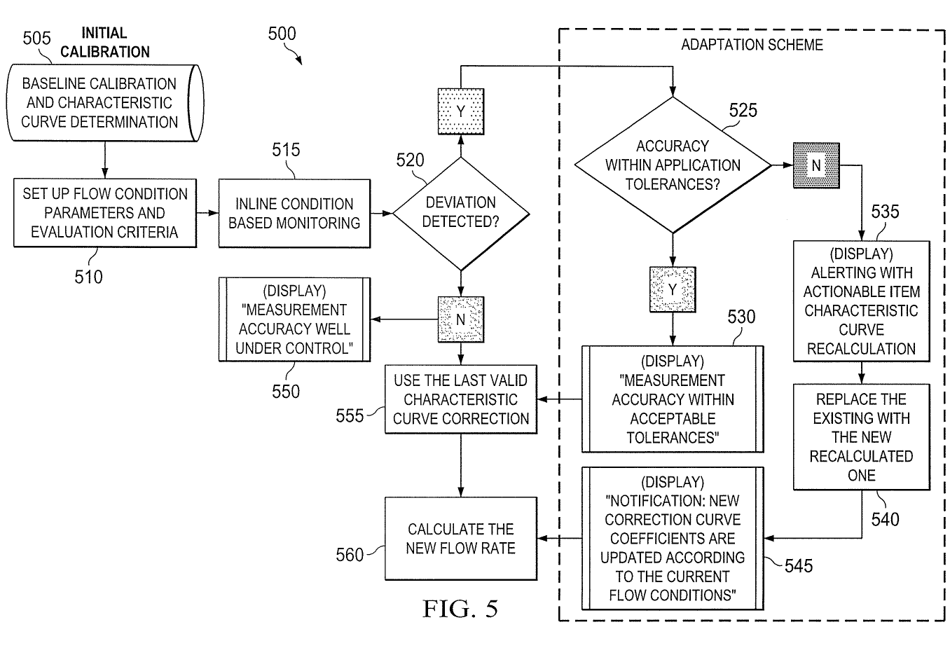

FIG. 3 illustrates different examples of pipes 305 with bends that can affect the flow profile of the fluid according to this disclosure. FIGS. 4A and 4B illustrate examples of potential disturbed profiles according to this disclosure.

The different pipes 305 illustrated in FIG. 3 include bends 310 that influence the flow profile. Different bends 310 or amount of bends 310 impact the flow profile causing disturbed flow profiles such as a cross flow or asymmetrical flow profile 400 (shown in FIG. 4A) or a swirl profile 405 (shown in FIG. 4B). While a number of piping bends 310 are illustrated, any bend or amount of bends could cause disturbed profiles. The cross flow or asymmetrical flow profile 400 and swirl profile 405 are non-limiting examples of possible flow profiles for different piping bends 310.

Although FIG. 3 illustrates details for different pipes 305, various changes may be made to FIG. 3. For example, the number(s) and type(s) of components shown in FIG. 3 are for illustration only. Various components in FIG. 3 could be omitted, combined, or further subdivided and additional components could be added according to particular needs.

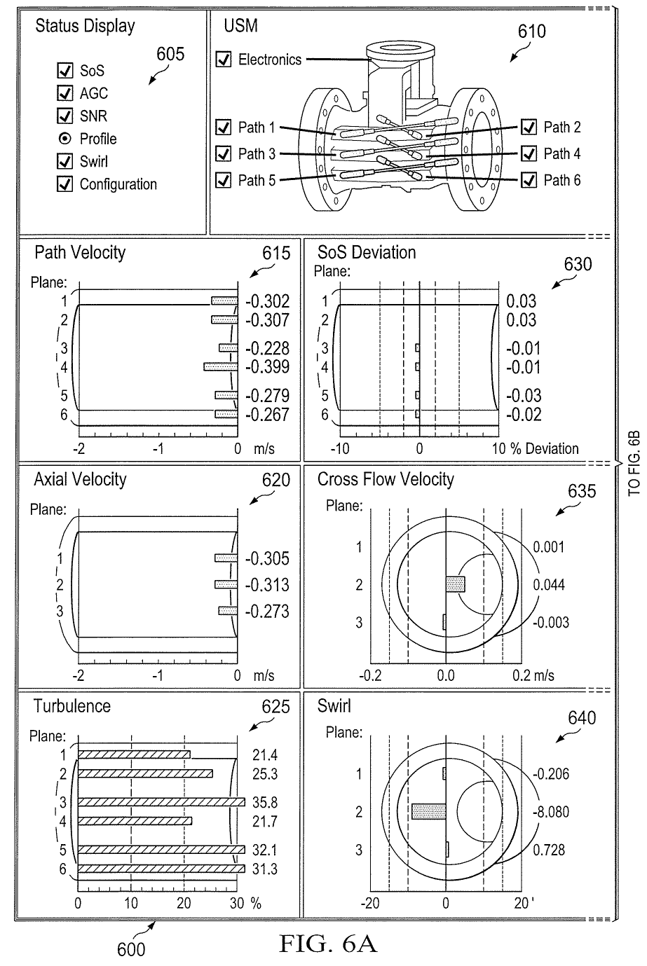

FIG. 5 illustrates a method 500 for CBM-based accuracy performance detection and self-adaptation according to this disclosure. For ease of explanation, the method 500 is described with respect to the field device 200 shown in FIG. 2, pipes 305 of FIG. 3, and disturbed flow profiles 400-405 of FIG. 4A and 4B. However, the method 500 could be used by any suitable field device and in any suitable system.

In block 505, the field device 200 performs a baseline calibration and characteristic curve determination for the fluid flow through the field device 200. In block 510, the field device 200 sets up the flow condition parameters and evaluation criteria. In block 515, the field device 200 performs the inline condition based monitoring. In block 520, the field device 200 determines whether a deviation in the measurement accuracy of a first characteristic curve for a flow profile of a process fluid is detected while monitoring an inline condition of the process fluid. The process fluid hereunder can be gas or liquid.

If a deviation in the accuracy is detected, then in block 525, the field device 200 determines whether the a deviation in the measurement accuracy is greater than an application tolerance. The application tolerance can be a set value or based on a percentage of the range. In certain embodiments, the application tolerance is determined by an industry standard, such as the International Organization of Legal Metrology (OIML) class 0.5 where the maximum acceptable error is 0.07 m/s with an averaging time of approximately 20 minutes.

In block 530, when the deviation in the accuracy that is detected is within the application tolerance, the field device 200 displays a message 215 indicating that the deviation is acceptable. In certain embodiments, the message states “measurement accuracy within acceptable tolerances.”

In block 535, when the deviation in the accuracy that is detected is not within the application tolerance, the field device 200 displays a warning message 215 stating the measurement accuracy might affect the results of the field device measurements and calculations, and also that investigation and verification are required.

In block 540, the field device 200 performs an inline recalculation for a new characteristic curve according to the present flow condition detected in measurements of the flow profile when the deviation is greater than the application tolerance. The new characteristic curve replaces the outdated characteristic curve that created an unacceptable deviation under the present flow conditions. In block 545, the field device 200 displays a message indicating that the characteristic curve is updated when the new characteristic curve replaces the old characteristic curve. In certain embodiments, the field device 200 displays the message “notification: new correction curve coefficients are updated according to the present flow conditions.”

In block 550, when a deviation in the accuracy is not detected, the field device 200 displays a message stating that the measurement accuracy of the sensors of the field device is well under control. In block 555, the field device 200 uses the last valid characteristic curve correction on the measurements of the sensors. In block 560, the field device 200 calculates a flow rate using the new characteristic curve for the fluid passing through the field device 200 after the field device 200 displays a message indicating that the characteristic curve is updated when the new characteristic curve replaces the old characteristic curve.

Although FIG. 5 illustrates one example of a method 500 for measuring smaller dimensions in fluids, various changes may be made to FIG. 5. For example, while shown as a series of steps, various steps shown in FIG. 5 could overlap, occur in parallel, or occur multiple times. Moreover, some steps could be combined or removed and additional steps could be added.

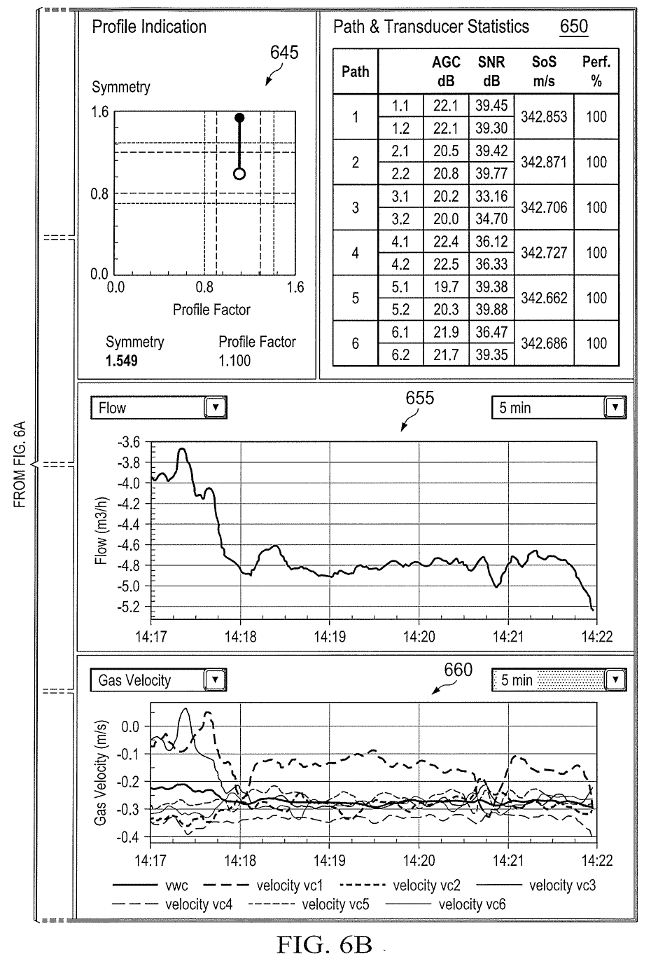

FIG. 6 illustrates an example CBM display 600 for a field device according to this disclosure. For ease of explanation, the example display 600 is described as being used in the field device 200 of FIG. 2. However, the example display 600 could be used in any other suitable system or device, such as flow computer 220 or computer 225.

The example display 600 includes, but is not limited to, a status display 605, a USM overview 610, a path velocity graph 615, an axial velocity graph 620, a turbulence graph 625, an speed of sound (SoS) deviation graph 630, a cross flow velocity graph 635, a swirl graph 640, a profile indication graph 645, a path and transducer chart 650, a first comparison graph 655, and a second comparison graph 660.

The status display 605 includes control options for the other graphs and charts included on the display 600. In certain embodiments, the status display 605 includes options for the speed of sound, the automatic gain control (AGC), the SNR, the profile, swirl, and configurations. Each option can be selected for incorporation of the different graphs and charts on the display 600.

The USM CBM overview 610 includes additional control options for the other graphs and charts included on the display 600. The control options in the USM overview 610 include different flow paths and the electronics. Each flow path and the electronics can be selected for incorporation of the different graphs and charts on the display 600.

The path velocity graph 615 displays a velocity determined for each selected flow path. The axial velocity graph 620 displays an axial velocity determined for each plane. The turbulence graph 625 displays a turbulence determined for each selected flow path. The SoS deviation graph 630 displays a SoS deviation determined for each selected flow plane. The cross flow velocity graph 635 displays a difference in cross flow between flow paths on a flow plane determined for each selected flow plane. The swirl graph 640 displays a swirl detected from the flow paths on a plane determined for each selected flow plane. Each of the graphs 615-640 includes results based on the control options selected in the status display 605. The planes are determined by flow paths that are at the same level in the field device. The results are displayed in both graphical and numerical form for easy comparison between flow paths or planes and identification of individual characteristics of each flow path or plane. The measurement units are either defined by a user or automatically decided by the field device based on factors, such as a maximum reading or a tolerance level. As illustrated in the turbulence graph 625, different colors or other indicators are used to show intensity of the levels or deviations in the flow paths or planes. The graphs 615-640 include different levels of accuracy, including high accuracy, monitor accuracy, and inaccurate.

The profile indication graph 645 illustrates an example of a symmetry and a profile factor. The path and transducer chart 650 includes numerical data from the readings from each sensor and each flow path. The first comparison graph 655 and the second comparison graph 660 display graphs of a selected attribute over a period of time. The attribute can include any of the attributes found in graphs 615-640 and also the total flow rate of the process fluid inside the field device 200.

Although FIG. 6 illustrates details for example display 600, various changes may be made to FIG. 6. For example, the number(s) and type(s) of components shown in FIG. 6 are for illustration only. Also, the functional divisions of the example display 600 are for illustration only. Various components in FIG. 6 could be omitted, combined, or further subdivided and additional components could be added according to particular needs.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. §112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. §112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
a control system configured to communicate data with one or more field devices; and
a field device configured to:
determine whether a deviation in a measurement accuracy of a first characteristic curve for a flow profile of a process fluid is detected while monitoring an inline condition of the process fluid;
determine whether the deviation is greater than an application tolerance;
perform an inline recalculation for a new characteristic curve according to present flow condition detected in measurements of the flow profile when the deviation is greater than the application tolerance; and
calculate a flow rate of the process fluid using the new characteristic curve.

2. The system of claim 1, wherein the field device is further configured to display a warning message indicating a level of the measurement accuracy is significantly affected.

3. The system of claim 1, wherein the field device is further configured to replace the first characteristic curve with the new characteristic curve.

4. The system of claim 3, wherein the field device is further configured to display a message indicating the characteristic curve is updated when the first characteristic curve is replaced by the new characteristic curve.

5. The system of claim 1, wherein the field device is configured to monitor the inline condition of the process fluid in real-time as the process fluid flows through the field device.

6. The system of claim 1, wherein the field device is further configured to set up boundary detection criteria, and wherein the boundary detection criteria include a tolerance for each monitored measurement.

7. The system of claim 1, wherein the deviation is caused by an asymmetrical flow, a swirl flow, or any other disturbances.

8. A field device configured to:
determine whether a deviation in a measurement accuracy of a first characteristic curve for a flow profile of a process fluid is detected while monitoring an inline condition of the process fluid;
determine whether the deviation is greater than an application tolerance;
perform an inline recalculation for a new characteristic curve according to present flow condition detected in measurements of the flow profile when the deviation is greater than the application tolerance; and
calculate a flow rate of the process fluid using the new characteristic curve.

9. The field device of claim 8, wherein the field device is further configured to display a warning message indicating a level of the measurement accuracy is significantly affected.

10. The field device of claim 8, wherein the field device is further configured to replace the first characteristic curve with the new characteristic curve.

11. The field device of claim 10, wherein the field device is further configured to display a message indicating the characteristic curve is updated when the first characteristic curve is replaced by the new characteristic curve.

12. The field device of claim 8, wherein the field device is further configured to monitor the inline condition of the process fluid in real-time as the process fluid flows through the field device.

13. The field device of claim 8, wherein the field device is further configured to set up boundary detection criteria, and wherein the boundary detection criteria include a tolerance for each monitored measurement.

14. The field device of claim 8, wherein the deviation is caused by an asymmetrical flow, a swirl flow, or any other disturbances.

15. A method comprises:
determining whether a deviation in a measurement accuracy of a first characteristic curve for a flow profile of a process fluid is detected while monitoring an inline condition of the process fluid;
determining whether the deviation is greater than an application tolerance;
performing an inline recalculation for a new characteristic curve according to present flow condition detected in measurements of the flow profile when the deviation is greater than the application tolerance; and
calculating a flow rate of the process fluid using the new characteristic curve.

16. The method of claim 15, further comprises displaying a warning message indicating a level of the measurement accuracy is significantly affected.

17. The method of claim 15, further comprises replacing the first characteristic curve with the new characteristic curve.

18. The method of claim 17, further comprises displaying a message indicating the characteristic curve is updated when the first characteristic curve is replaced by the new characteristic curve.

19. The method of claim 18, further comprises monitoring the inline condition of the process fluid in real-time as the process fluid flows through the field device.

20. The method of claim 15, further comprises setting up boundary detection criteria, and wherein the boundary detection criteria include a tolerance for each monitored measurement.
